(19) United States
(12) Patent Application Publication
(10) Pub. No.: US 2026/0261059 A1
(43) Pub. Date: Sep. 3, 2026

(54) CRIMP NECK

(71) Applicant: HUBER+SUHNER AG, CH-9100 HERISAU (CH)

(72) Inventors: Franz MANSER, Herisau (CH); Jean-Philippe DELLEMANN, Busswil (CH)

(73) Assignee: HUBER+SUHNER AG, CH-9100 HERISAU (CH)

(21) Appl. No.: 18/876,009

(22) PCT Filed: Jun. 7, 2023
(86) PCT No.: PCT/EP2023/065301

§ 371 Date: Dec. 17, 2024

(30) Foreign Application Priority Data
Jun. 20, 2022 (CH) CH000741/2022

(51) Int. Cl. H01R 9/05; H01R 43/048

(52) U.S. Cl. CPC H01R 9/0518; H01R 43/048

(57) ABSTRACT

A crimp neck (1) includes a collar (2) made from a metal that extends in a longitudinal direction (x). The crimp neck (1) includes a lateral surface (3) with several first grooves (4) which are arranged in the lateral surface (3) extending in circumferential direction and made by a first metal cutting process by removing metal from the collar (2). The lateral surface (3) further includes several second grooves (5) arranged in the lateral surface (3) distributed in circumferential direction and extending in longitudinal direction (x) of the collar (2).

### BACKGROUND OF THE INVENTION

### FIELD OF THE INVENTION

The present disclosure relates to a crimp neck made by a metal cutting process and such a metal cutting process.

### Discussion of Related Art

WO 03103095 A1, published on Nov. 12, 2003 by TRU Corp. relates to an electrical connector including a body with a mating connector end and a cable receptacle end having a cable opening therein for receiving at least a portion of a transmission line cable, A center conductor pin disposed in the connector body includes a receptacle structure having portions defining a receptacle opening extending there through. The receptacle opening is dimensioned for receiving a center conductor of the cable or an adapter pin. The cable receptacle portion may be dimensioned to allow a cable braid of the coaxial cable to be installed over the exterior surface, which may be knurled to resist axial movement of the braid relative to the portion.

U.S. Pat. No. 3,757,278, published on Apr. 9, 1973 by AMP Inc. relates to a subminiature coaxial contact having a cavity in one end for receiving a stripped center conductor of a small-size coaxial cable and being provided with a dielectric sleeve movably positioned thereon and initially disposed intermediate the ends thereof.

U.S. Pat. No. 3,296,363, published on Mar. 1, 1967 by AMP Inc. relates to a coaxial connector construction which includes a sleeve extension having serrations or grooves against which the metal of the connector crimping ferrule is formed. In one embodiment the extension surface is knurled in crossing and spiraled grooves to define surfaces which lock the connector against both twisting and pull-out forces. In the alternative embodiment, the extension surface is serrated in axial and tranversal grooves, which lock against such forces.

### SUMMARY OF THE INVENTION

Crimp necks are well-known connection elements to connect cables to connector housings. Especially knurled outer surfaces in combination with thereon arranged tubular crimp sleeves are widespread and common attachment means. Knurling is a manufacturing process, typically conducted on a lathe. A pattern of straight, angled or crossed lines is rolled into the material. In the context of crimp necks, knurling processes are known in form of cold forming processes. Typically knurling in form of knurl rolling is applied whereby one or more rollers containing the reverse of the pattern to be imposed are brought into contact with the surface of a slug. Although knurling is a cost efficient process with a high surface quality, the process of making the knurls by plastic deformation as well as the knurled surfaces themselves can have certain disadvantages.

As during the knurling process greater loads occur, the workpiece must have a higher wall thickness, which results in more material consumption. A thin-walled workpiece can usually not be knurled by a knurling process in which the material is plastically deformed because of the risk of deforming the overall workpiece. The applied forces can deform the main geometry in an unwanted manner. As knurling is a rolling process, the knurling tool is pressed against the surface to be knurled. The resulting bending forces can deform a thin-walled workpiece in an unwanted manner. In addition, cutting rates as well as feeding rates are lower compared to metal cutting processes, which results in a comparatively long machining process, in comparison to standard metal cutting processes like lathing or milling. Furthermore, there are material dependent limits to the achievable surface quality with brittle and less ductile metals.

Especially producing knurled surfaces with less ductile metals poses challenges. When producing knurled surfaces, cold formable ductile materials are required which allow the knurling tool, e.g. at least one roller, to squeeze the surface into the desired shape. Less ductile and more brittle metals and alloys tend to show micro cracks and bures on the knurled areas, as they only possess a limited cold forming ability. Besides the unsatisfying surface quality, also the kourling tools show a significant lower lifetime with less ductile and more brittle metals and alloys. Although unwanted burrs may be removed in a post processing step, although being difficult as they tend to be caught in the pyramidic recesses of the knurling structure, micro cracks remain as a serious problem with the risk over live-time to cause failure of the complete component driven by corrosion, fatigue and/or creeping.

The present disclosure therefore addresses a crimp neck with improved properties compared to a knurled surface known from the prior art.

A crimp neck according to the present disclosure usually comprises a collar, which is made from a metal and extends in a longitudinal direction. Although a wide variety of metals can be used, brass alloys are preferred as they provide good electrical conductivity, corrosion resistance and good machinability. Good results regarding the clamping forces due to crimping can be achieved, when the base body of the collar is designed as an essentially rotational symmetric part, preferably in form of a cylindrical sleeve. The collar can comprise additional means in the form of grooves (recesses) to increase traction between a braid, respectively an outer sheet of an electrical or optical cable and the crimp neck when clamped from the outside by a crimp sleeve. The crimp neck according to the present disclosure can be interconnected to a housing of a cable connector or be part of the housing.

The collar of the crimp neck typically comprises an outer lateral surface (shell surface of the collar). Good results can be achieved, when the lateral surface comprises a first section and a second section as described in more detail hereinafter. Depending on the design of the crimp neck, the first section and the second section of the lateral surface can have the same diameter and merge into each, respectively overlap with each other along the longitudinal direction. Alternatively, the first section and the second section can be separated from each other in the longitudinal direction by a circumferential channel or a recess. In addition, the first section and the second section can have diameters, which differ from each other, which leads to a staggered design.

Although knurling provides a surface structure with good mechanical behavior, two of the main drawbacks are unwanted deformations and material chipping which can cause a negative effect and often require additional manufacturing steps such as plating or grinding of the surface to obtain acceptable surface structure.

As knurling is a cold forming process, the forces applied to create the typical pattern with one or several rollers in circumferential direction requires comparatively thick-walled components. In addition, with less ductile metals unwanted material chipping can occur which leads to an unusable surface structure. Especially with less ductile materials, an improved design is desired which has similar properties regarding the holding effect of knurled surfaces. In particular, for attaching optical or electrical cables, etc. to a cable connector, multiple common cable types and diameters, cable constructions, connector designs, crimping elements and crimping tools lead to a huge variety of different crimping dimensions throughout various industries. As a consequence, a universal structure is desired which provides the desired holding performance and is applicable to various designs of the crimp neck, A collar that comprises grooves, made by one or several metal cutting processes, has shown similar properties regarding the pull-out resistance, compared to known knurled designs.

A crimp neck according to the present disclosure usually comprises a lateral surface with several first grooves and several, thereto adjacent or at least partially overlapping second grooves, which are preferably made by a metal cutting process, i.e. by removing material. The several first and the several second grooves are designed in a way that the crimp neck can be manufactured without cold forming, the material. Depending on the manufacturing process, the several first and several second grooves can be made in a single manufacturing process, e.g. by lathing and/or milling. Alternatively, the several first grooves can be made by lathing, while the several second grooves are made by a shaping process. The crimp neck can be used for attaching a cable to a connector body. Therefore, the crimp neck can comprise a through-hole, which extends in a longitudinal direction and is configured to receive at least an inner conductor of a cable. The crimp neck is typically configured for interconnecting a shielded braid or mesh of the cable to the cable connector. For an easy assembly and for flaring the shielded braid or mesh, without buckling the shielded braid or mesh, the crimp neck can comprise a lead-in surface merging into the lateral surface. In a variation, the lead-in surface is preferably arranged at a distal end of the crimp neck and designed funnel shaped. The diameter of the collar preferably widens from the distal end of the crimp neck towards the first section.

While less ductile and more brittle metals and alloys pose challenges for knurling processes as discussed in more detail above noted, these materials possess advantageous properties for machining and in particular metal cutting operations. For turning operations, in particular on automatic lathes, milling or the like, it is important that the material breaks in smaller chips, as ribbon and tangled chips are undesired as they tend to wind and cumulate around the tools and workpiece and thereby negatively affecting the surface quality of the workpiece and the lifespan of the tool. While more ductile materials result in ribbon and tangled chips, brittle materials break in smaller chips during machining operations. Especially in the context of brass alloys, so far alloys containing lead have been widely used as already low percentages of 1 to 3 % lead improve the machinability of the alloys, As lead-free materials are desired and required, due to current environmental standards, designs of the crimp neck are required which can be produced with lead free alloys without unwanted side effects like cracks or burrs. Alloys with added silicon additions, e.g. in alloys like CuZn21Si3P or CuZn36Si comprise an increased hardness and brittleness of the material. While these alloys show microcracks and bures on the knurled areas, they are suitable for metal cutting operations.

The several first grooves are preferably arranged in the lateral surface extending in circumferential direction and are made by a first metal cutting process by removing metal from the collar. Good results can be achieved when the several first grooves are made by an automatic lathe in the form of V-or U-shaped grooves. During the manufacturing process, the grooves are cut into the surface of the base body of the collar. In a variation, the grooves are V-or U-shaped grooves which provide a good holding effect as the wires or mesh of a shielded braid, respectively a foil are received by the groove and clamped by the crimp sleeve to the crimp neck in the mounted state. The wires or mesh is pressed into the grooves by the crimp sleeve. In addition, the geometry allows the use of standardized tool bits. Good results regarding both the clamping effect and a smooth transition of forces without pressure peaks can be achieved when the several first grooves have a rounded bottom. One of the advantages regarding the design of the several first grooves and several second grooves is that the depth of the several first and several second grooves can be kept smaller than the depth of pyramidic recesses of corresponding knurled designs, which weakens the crimp neck less mechanically. This allows to reduce the overall wall thickness.

For producing the crimp neck with several first and several second grooves, typically an essentially cylindrical slug is provided which is clamped onto a processing machine. For clamping the slug onto the processing machine, the slug and later also the finished crimp neck can comprise a clamping surface. The collar of the crimp neck typically merges at the dorsal end of the crimp neck into a clamping surface by which the crimp neck is held during the metal cutting process. The clamping surface is typically designed as a cylindrical or polygonal neck, which has a larger diameter than the diameter of the collar. The several first grooves arranged in the lateral typically extend in circumferential direction and are cut in a first metal cutting process by surface removing metal from the base body of the collar.

Good results can be achieved when the several first grooves are cut by means of a tool bit on a lathe or the like, wherein the crimp neck is clamped onto the machine and rotates relative to the tool bit. The several first grooves can be designed as annular grooves which are arranged adjacent to each other in longitudinal direction. The several first grooves arranged adjacent to one another, can be arranged from a dorsal end of the lateral surface to a distal end of the lateral surface. In a mounted state the several first grooves are configured to attach e.g. a shielded braid, mesh or foil and to prevent slippage along the longitudinal direction.

To also avoid slippage of the shielded braid, mesh or foil in the mounted state in circumferential direction, several second grooves can be arranged in the base body of the collar, in the lateral surface distributed in circumferential direction. The several second grooves typically extend in longitudinal direction of the collar. The several second grooves are preferably made by a second metal cutting process by removing metal from the base body of the collar. Alternatively, the several second groves can be made by a shaping and or forming process. While the several first grooves typically have a rounded bottom, the several second grooves can have a pointed cross section.

The several second grooves can be arranged at a slight angle with respect to the longitudinal direction, creating a helix orientation similar to a thread. Depending on the chosen metal cutting process, the several first grooves can be produced before the several second grooves are produced or vice versa. The sequence of the metal cutting processes depends on the design of the crimp neck and the chosen manufacturing process. The second metal cutting process can therefore be also performed first and vice versa. In addition, the several first grooves and the several second grooves can be made in one process step whereby the first metal cutting process and the second metal cutting process are in fact one cutting process. Producing the several first grooves by a first metal cutting process before the several second grooves are produced by a second metal cutting process can have the advantage that the chips in the axial grooves break in shorter chips when the cutting tool passes through the several first grooves. The several second grooves in form of longitudinal grooves can be milled or shaped.

The depths and width of the respective groves play a role as the depth has an influence on the holding force in form of friction and the geometry of the grooves results in a positive locking of the therein attached wires or braid. A deep groove may result in the crimped material not reaching the bottom of the respective groove. With a narrow groove there may be the risk that material is sheared off and thus holding force is reduced. The geometry, in particular the width and/or depth of the several first grooves can also be varied. In particular with an increasing depth and/or width from the distal end to the dorsal end, e.g., by also slightly increasing the outside diameter of the collar. This allows the force application to be better distributed along the length and higher pull-out forces to be achieved.

It is also important that the edges of the respective grooves are not too sharp e.g. not at right angles, as a sharp angle can result in the crimped material being sheared off. Good results can be achieved with a 90° V-groove, whereby the edges being 135°.

Good results can be achieved when the several second grooves are cut by a planing tool. After cutting the several first grooves, the several second grooves can be cut in one clamping on the same machine and/or the same tool. If appropriate, the first and the second metal cutting process can be the same, The several second grooves can be cut by moving the planning tool with respect to the lateral surface along the longitudinal direction, whereby at least one cutting edge of the planning tool penetrates the lateral surface. Alternatively, the second grooves can be also cut by a form cutter. For a symmetric load distribution in circumferential direction the several second grooves are arranged in the lateral surface rotational symmetric, preferably equally distributed in circumferential direction.

The several second grooves typically extend in the longitudinal direction of the collar and are made in a second metal cutting process by removing metal from the collar, In a variation, the several first and the several second grooves can be arranged adjacent to each other. The several first grooves can be arranged at the first section of the lateral surface and the several second grooves can be arranged at the second section of the lateral surface. The several second grooves can de designed such that a respective first end of the several second grooves merges into the lead-in surface and a second end of the respective second groove merges into a first of the several first grooves. Depending on the design of the crimp neck, the first section and the second section of the lateral surface can have the same diameter such that the several first grooves can merge into the several second grooves. The several first grooves are preferably arranged adjacent to the distal end of the crimp neck and/or the several second grooves are arranged adjacent to the dorsal end.

Alternatively, or in addition, the several first and the several second grooves at least partially overlap with each other forming a grid pattern in the overlapping area. The several second grooves can be arranged parallel with respect to the longitudinal direction forming a grid pattern with the several first grooves which are arranged transversal with respect to the longitudinal direction. The grid can be rectangular with respect to the longitudinal direction. The several second grooves can be solely arranged at the first section of the lateral surface or in addition extend from the distal of the crimp neck towards the dorsal end. The several second grooves typically protrude in distal direction above the several first grooves. The several second grooves can thereby pierce though the several first grooves. This is particularly advantageous for production as it allows adding the structure to the lateral surface in one single production step. Depending on the field of application and therefore the geometry of the wires of the shielded braid or alternatively the thickness of the foil, the several first grooves are at least partially deeper than the several second grooves or vice-versa.

Tests have shown that a limited number of second grooves in form of V-or U-shaped grooves along the longitudinal direction leads to cable retention and torque resistance similar to a knurled surface. For a cylindrical or hexagonal crimp sleeve a number of at least six to ten or up to 60, grooves extending from the distal end into the first one or up to three first grooves arranged adjacent to the distal end of the crimp neck show comparable results regarding pull-out resistance against twisting in comparison to a knurled surface. With a given diameter of the collar, the depth of the several first grooves and the depth of the several second grooves can be smaller than the depth of smallest knurl in use.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims.

FIG. 1 shows a perspective view of a first variation of the crimp neck with a thereto attached cable and crimp sleeve with a partial cut out;

FIG. 2 shows a perspective exploded view of the first variation of the crimp neck according to FIG. 1 with the thereto attached cable and crimp sleeve;

FIG. 3 shows a perspective view of the first variation of the crimp neck;

FIG. 4 shows a perspective view of a second variation of the crimp neck;

FIG. 5 shows a perspective view of a third variation of the crimp neck;

FIG. 6 shows a perspective view of a fourth variation of the crimp neck; and

FIG. 7 shows perspective view of a fifth variation of the crimp neck.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

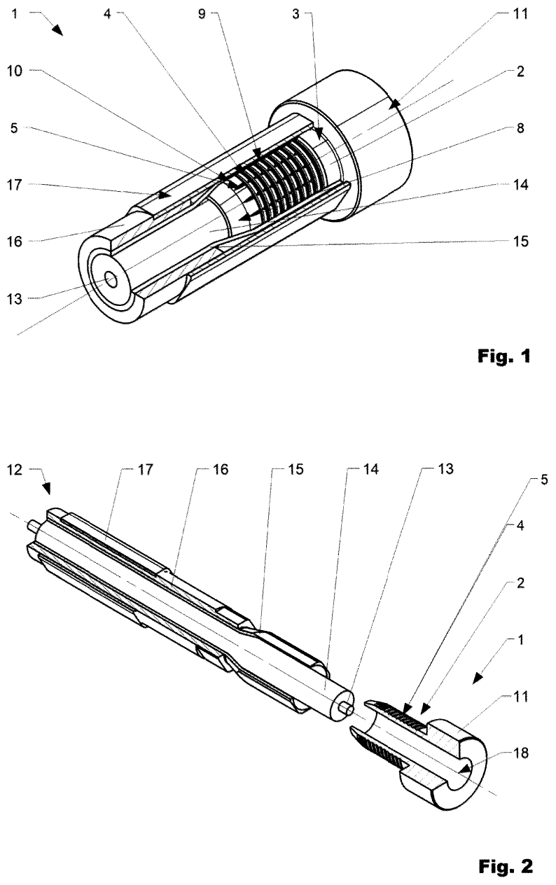

FIGS. 1 and 2 show a perspective view of a first variation of the crimp neck 1 with a thereto attached cable and crimp sleeve. FIG. 1 shows the first variation of the crimp neck 1 with a partial cut out and FIG. 2 shows the first variation of the crimp neck 1 in an exploded view. The shown variation of the crimp neck 1 comprises a collar 2 which is made from a metal and extends in a longitudinal direction x. As can be obtained best from FIG. 1, the shown collar 2 is designed as an essentially rotational symmetrical part with respect to the longitudinal direction x. This leads to good results regarding the transmission of forces in the mounted state in circumferential direction. In the shown variation the collar 2 is designed as a cylindrical sleeve which is used for attaching a cable to a cable connector. The shown cable, which is not part of the claimed crimp neck 1 or connector, comprises an inner conductor 13 encompassed by an insulation layer 14 encompassed by an outer conductor in form of a shielded braid 15 encompassed by a cable jacket 16. The shielded braid 15 is in the shown variation attached to the crimp neck 1 by a crimp sleeve 17 in form of a cylindrical or polygonal crimp sleeve, which is in the mounted state deformed in circumferential direction. The shown crimp neck 1 can be part of a cable connector, which comprises the crimp neck 1 and a connector body for interconnecting the cable. The shown variation of the crimp neck 1 is made as a separate part which is connected to the connector body. Alternatively, the crimp neck 1 and the connector body can be made in an integral manner.

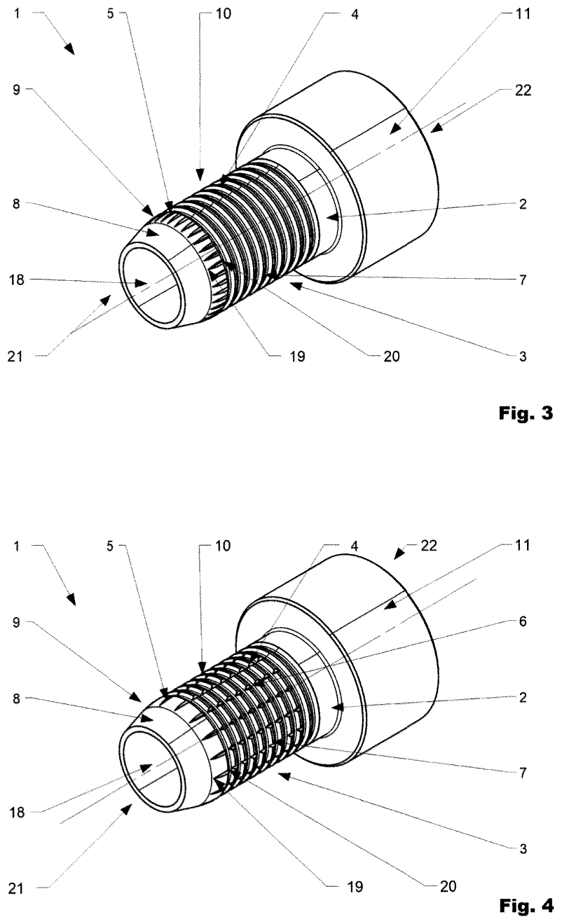

FIGS. 3 to 6 show the first through the fourth variation of the crimp neck 1. All shown variations of the crimp neck 1 comprise a collar 2 which comprises a lateral surface 3 which corresponds to the shell surface of the collar 2. The lateral surfaces 3 of the shown variations comprise a first section 9 and a second section 10 which first section 9 merges into the second section 10. The respective lateral surfaces 3 of all shown variations of the crimp neck 1 comprise several first grooves 4 and several second grooves 5. The several first 4 and the several second grooves 5 are designed to allow manufacturing of the crimp neck 1 without forming, in particular without cold forming, the material.

The shown crimp necks 1 are preferably used for attaching a cable to a connector body. Therefore, all the shown variations of the crimp neck 1 comprise a through-hole 18, which extends along the longitudinal direction x and is configured to receive the inner conductor 13 of a cable. The shown crimp necks 1 are typically configured for attaching a shielded braid 15 of the cable to the cable connector. For easy assembly and for flaring the shielded braid 15, all the shown crimp necks 1 comprise a lead-in surface 8 which merges into the lateral surface 3. The lead-in surfaces 8 of the shown variations are designed funnel shaped and merge into the first section 9. The several first grooves 4 are arranged in the lateral surface 3 and extend in circumferential direction. The several first grooves 4 are made by a first metal cutting process by removing metal from the collar 2.

Good results can be achieved when the several first grooves 4 are made by an automatic lathe in the form of V-or U-shaped grooves. Good results regarding both the clamping effect and a smooth transition of forces without pressure peaks can be achieved when the several first grooves 4 have a rounded bottom 7. The shown variations of the crimp neck 1 are designed such that the first section 4 and the second section 10 of the lateral surface 3 have the same diameter and merge into each other. Alternatively, the first section 9 and the second section 10 can be separated from each other in the longitudinal direction by a channel or recess. Alternatively, or in addition, the first section 9 and the second section 10 can have diameters, which differ from each other, which leads to a staggered design of the collar 2.

As can be obtained best from FIG. 3, in the first variation the several first 4 and the several second grooves 5 are arranged adjacent to each other. The several first grooves 4 are arranged at the first section 9 of the lateral surface 3 and the several second grooves 5 are arranged at the second section 10 of the lateral surface 3. In the shown variation the several second grooves 5 are designed such that a respective first end 19 of the several second grooves 5 merges into the lead-in surface 8 and a second end 20 of the respective groove 5 merges into the several first grooves 4. Depending on the design of the crimp neck 1, the first section 9 and the second section 10 of the lateral surface 3 can have the same diameter such that the several first grooves 4 can merge into the several second grooves 5. The several first grooves 4 are preferably arranged adjacent to the distal end 21 of the crimp neck 1 and/or the several second grooves 5 are arranged adjacent to the dorsal end 22 of the crimp neck 1.

As can be obtained from FIGS. 4 to 6, the second through the fourth variation each comprise several first 4 and several second grooves 5 which at least partially overlap with each other forming a grid pattern 6 in the overlapping area. The shown several second grooves 5 are arranged parallel with respect to the longitudinal direction x forming a grid pattern 6 with the several first grooves 4, wherein the grid pattern 6 is rectangular with respect to the longitudinal direction x. The several second grooves 5 are not only arranged at the first section 9 of the lateral surface 3 but in addition extend from the distal end 21 of the crimp neck 1 towards the dorsal end 22, The shown several second grooves 5 protrude in distal direction above the several first grooves 4. This is particularly advantageous for production as it allows to add the grooves to the lateral surface 3 in one single production step.

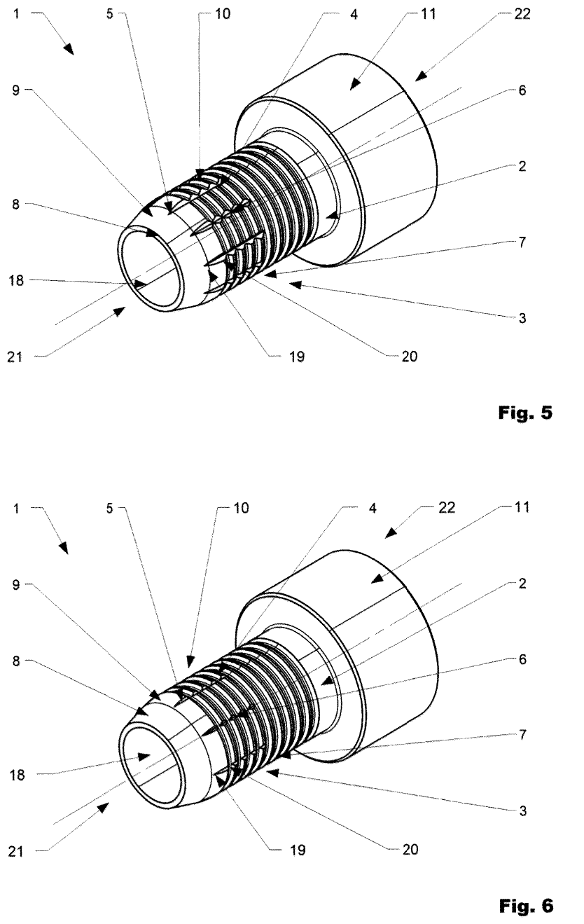

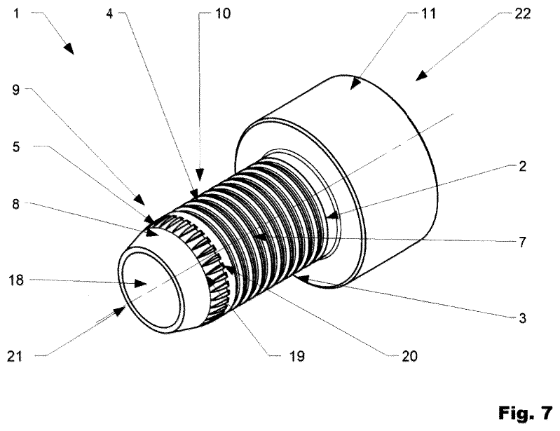

As can be obtained from FIGS. 5 and 6, depending on the design, the several second grooves 5 can extend along the longitudinal direction x from the first section 9 of the lateral surface 3 into the second section 10 of the lateral surface 3. Depending on the field of application and therefore the geometry of the wires of the shielded braid or alternatively the thickness of the foil, the several first grooves 4 are at least partially deeper than the several second grooves 5 or vice-versa. All variations shown by FIGS. 4 to 6 have in common that already a limited number of second grooves 5 in form of V-or U-shaped grooves along the longitudinal direction x leads to a cable retention and torque resistance similar to a knurled surface. For a cylindrical or hexagonal crimp sleeve 17 already six grooves extending from the distal end 21 into the first one or up to three first grooves 4 arranged adjacent to the distal end 21 of the crimp neck 1 show comparable results regarding pull-out resistance against twisting in comparison to a knurled surface. With a given diameter of the collar 2, the depth of the several first grooves 4 and the depth of the several second grooves 5 can be smaller than the depth of smallest knurl in use for the same diameter.

For producing the several first grooves 4 of any of the variations shown by FIGS. 4 to 7, typically an essentially cylindrical slug is provided which is clamped onto a processing machine. For clamping the slug onto the processing machine, the slug and the finished crimp neck 1 can comprise a clamping surface 11. The lateral surface 3 typically merges at its dorsal end 22 into a clamping surface 11 by which the crimp neck 1 is held during the metal cutting process. The clamping surface 11 is typically designed as a cylindrical or polygonal neck which has a wider diameter then the collar 2 of the crimp neck 1. The several first grooves 4 arranged in the lateral surface 3 extend in circumferential direction and are cut in a first metal cutting process by removing metal from the collar 2. Good results can be achieved when the several first grooves 4 are cut by means of a tool bit, wherein the lateral surface 3 rotates relative to the tool bit. The several first grooves 4 are designed as annular grooves which are arranged adjacent to each other in longitudinal direction x. The several first grooves 4 extend from the dorsal end 22 of the lateral surface 3 to the distal end 21 of the lateral surface 3. In a mounted state the several first grooves 4 are configured to attach e.g. a shielded braid, mesh or foil and to prevent slippage along the longitudinal direction x. FIG. 3 shows a variation wherein the several second grooves 5 are arranged adjacent to the several first grooves 4. In comparison, FIG. 7 shows a variation wherein the several second grooves 5 are arranged spaced a distance apart to the several first grooves 4. The gap between the several second grooves 5 and the several first grooves 4 can be designed as a groove.

The shown several second grooves 5 of all variations shown by FIGS. 4 to 7 are made by a second metal cutting process by removing metal from the collar 2. While the several first grooves 4 typically have a rounded bottom, the shown several second grooves 5 have a pointed cross section. Good results can be achieved when the several second grooves 5 are cut by a planing tool. After cutting the several first grooves 4, the several second grooves 5 are typically cut by moving the planing tool with respect to the lateral surface 3, whereby at least one cutting edge of the planning tool penetrates the lateral surface 3. The shown several second grooves 5 are arranged in the lateral surface 3 distributed in circumferential direction. The several second grooves 5 are equally spaced with respect to each other and extend in longitudinal direction x of the collar 2.

Rather, the words used in the specification are words of description rather than limitation, and it is understood that various changes may be made without departing from the Spirit and scope of the disclosure.

1. A crimp neck (1) comprising:
a collar (2) made from a metal extends in a longitudinal direction (x). the collar comprising a lateral surface (3);
several first grooves (4) are arranged in the lateral surface (3) extending in a circumferential direction and made by a first metal cutting process by removing metal from the collar (2); and
several second grooves (5) arranged in the lateral surface (3) distributed in the circumferential direction and extending in the longitudinal direction (x) of the collar (2).

2. The crimp neck (1) according to claim 1, wherein the several first and the several second grooves (4,5) are arranged adjacent to each other or are arranged spaced apart from each other

3. The crimp neck (1) according to claim 1, wherein the several first and the several second grooves (4, 5) at least partially overlap with each other forming a grid pattern (6) in the overlapping area.

4. The crimp neck (1) according to claim 3, wherein the grid pattern (6) is rectangular.

5. The crimp neck (1) according to claim 1, wherein the several first grooves are at least partially deeper than the several second grooves (5) or vice-versa.

6. The crimp neck (1) according to claim 1, wherein the several first grooves (4) have a rounded bottom (7) and the several second grooves (5) have a pointed cross section.

7. The crimp neck (1) according to claim 1, wherein the crimp neck (1) comprises a lead-in surface (8) merging into the lateral surface (3).

8. The crimp neck (1) according to claim 1, wherein the several second grooves (5) are made by a second metal cutting or shaping process by removing metal from the collar (2).

9. The crimp neck (1) according to claim 1, wherein the several second grooves (5) protrude in a distal direction above the several first grooves (4).

10. The crimp neck (1) according to claim 1, wherein the several second grooves (5) are in the circumferential direction arranged rotational symmetric.

11. The crimp neck (1) according to claim 1, wherein the lateral surface (3) merges at a dorsal end into a clamping surface (11) by which the crimp neck (1) is held during the metal cutting process.

12. A cable connector (12) comprising the crimp neck (1) according to claim 1 and a connector body.

13. A method for producing a crimp neck (1) according to claim 11, comprising the following steps:
providing a slug;
clamping the slug onto a processing machine via the clamping surface (11);
cutting of several first grooves (4) arranged in the lateral surface (3) extending in circumferential direction in a first metal cutting process by removing metal from the collar
cutting of several second grooves (5) arranged in the lateral surface (3) distributed in circumferential direction and extending in longitudinal direction (x) of the collar (2) in a second metal cutting process by removing metal from the collar (2); and
removing the finished crimp neck (1) from the processing machine.

14. The method for producing a crimp neck (1) according to any of claims 13, wherein the several first grooves (4) are cut by means of a tool bit, wherein the lateral surface (3) rotates relative to the tool bit, whereby at least one cutting edge of the tool bit penetrates the lateral surface.

15. The method for producing a crimp neck (1) according to claim, wherein the several second grooves (5) are cut by a planing tool, which is moved along the longitudinal direction (x), whereby at least one cutting edge of the circular tool penetrates the lateral surface,

16. The method for producing a crimp neck (1) according to claim 13, wherein the several first grooves (4) which are cut in a first metal cutting process by removing metal from the collar (2) are cut before the several second grooves (5) are cut in a second metal cutting process by removing metal from the collar (2) or vice versa.
